(19) United States
(12) Patent Application Publication
(10) Pub. No.: US 2010/0118920 A1
(43) Pub. Date: May 13, 2010

(54) SATELLITE COMMUNICATION TRANSMITTER AND RECEIVER FOR REDUCING CHANNEL INTERFERENCE

(75) Inventors: Pan-soo KIM, Daejeon-si (KR); Dae-ig CHANG, Daejeon-si (KR); Ho-jin LEE, Daejeon-si (KR); A. VANELLI-CORALLI, Bologna (IT); G.E. CORAZZA, Bologna (IT); C. PALESTINI, Bologna (IT); R. PEDONE, Bologna (IT); M. VILLANTI, Bologna (IT)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/536,952

(22) Filed: Aug. 6, 2009

(30) Foreign Application Priority Data
Nov. 11, 2008 (KR) 10-2008-0111698

(51) Int. Cl. H04B 1/707

(52) U.S. Cl. 375/141; 375/146; 375/147; 375/149; 375/E01.002

(57) ABSTRACT

Satellite communication transmitter and receiver in a DVB-S2 system are provided. The satellite communication transmitter includes a modulator to modulate a satellite communication signal to be transmitted, and a spread spectrum unit to spread the modulated signal and transmit the spread signal. Accordingly, it is possible to reduce interference with a neighboring channel.

### CROSS-REFERENCE TO RELATED APPLICATION

This application claims the benefit under 35 U.S.C. §119(a) of Korean Patent Application No. 10-2008-111698, filed on Nov. 11, 2008, the disclosure of which is incorporated by reference in its entirety for all purposes.

### BACKGROUND

1. Field

The following description relates to a satellite communication system and, more particularly, to a transmitter and receiver of a satellite communication system.

2. Description of the Related Art

A satellite communication system, such as DVB-S2 (Second Generation Digital Video Broadcasting via Satellite), employs an adaptive coding and modulation (ACM), which adaptively selects and transmits optimal modulation and coding rates depending on satellite communication channel conditions, to expand satellite channel capacity up to 100 to 200%. However, a limited off-axis beam width of a terminal or relay amplifier at Ku/Ka bandwidth in a satellite communication may cause interference with neighboring satellite channels. This interference is increasingly significant in motion. This interference may also cause a poor SINR (signal to interface and noise ratio) of a neighboring satellite channel, resulting in degraded performance of the entire system.

### SUMMARY

The following description relates to satellite communication transmitter and receiver which have reduced interference with neighboring satellite channels.

In one general aspect, a satellite communication transmitter includes a modulator to modulate a satellite communication signal to be transmitted, the satellite communication transmitter further including a spread spectrum unit to spread the modulated signal and transmit the spread signal.

The satellite communication transmitter may be configured to comply with DVB-S2 (Second Generation Digital Video Broadcasting via Satellite) standard.

The spread spectrum unit may include: a matched filter to perform matched filtering on an orthogonal signal output from the modulator; and a DSSS unit to spread the matched filtered orthogonal signal using the DSSS technique. The spread spectrum unit may further include a decimator to perform one sample decimation per symbol on an oversampled signal output from the matched filter and output the decimated signal to the DSSS unit.

In another general aspect, a satellite communication receiver includes a demodulator to demodulate a satellite communication signal, the satellite communication is receiver further including a despreading unit to despread the spread satellite communication signal and output the despreaded signal to the demodulator.

The satellite communication receiver may be configured to comply with DVB-S2 (Second Generation Digital Video Broadcasting via Satellite) standard.

The despreading unit may include: a direct sequence despreading part to perform despreading on the received satellite communication signal using a DSSS technique; an oversampling part to perform oversampling on the despreaded signal; and a pulse shaping part to perform pulse shaping filtering on the despreaded signal.

The direct sequence despreading part may include: a matched filter part to perform matched filtering on the received satellite communication signal; a code synchronization part to perform code synchronization on a signal output from the matched filter part; a decimation part to perform one sample decimation per symbol on an oversampled signal output from the code synchronization part; a spread spectrum code part to multiply a signal output from the decimation part by a spread spectrum code; and a descrambling part to perform descrambling on a signal output from the spread spectrum code part.

However, other features and aspects will be apparent from the following description, the drawings, and the claims.

### BRIEF DESCRIPTION OF THE DRAWINGS

FIG. 1 is a block diagram of a satellite communication transmitter in a DVB-S2 system according to an exemplary embodiment of the present invention.

FIG. 2 is a block diagram of a satellite communication receiver in a DVB-S2 system according to an exemplary embodiment of the present invention.

FIG. 3 is a graph illustrating oversampling points of a modulated satellite communication signal.

FIG. 4 is a flow chart of calculation of ‘on timing information’.

FIG. 5 is a state transition diagram for initial chip timing synchronization.

FIG. 6 illustrates a correlator for initial chip synchronization.

FIG. 7 illustrates another correlator for initial chip synchronization.

FIG. 8 illustrates another correlator for initial chip synchronization.

FIG. 9 illustrates another correlator for initial chip synchronization.

FIG. 10 is a graph for performance comparison of a non-linear amplifier model depending on spread spectrum.

FIG. 11 is a graph for performance comparison of a mobile model depending on spread spectrum.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

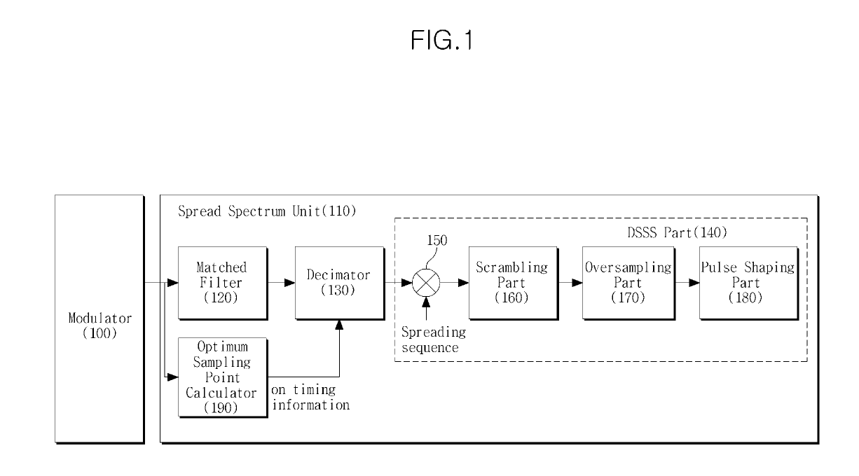

FIG. 1 is a block diagram of a satellite communication transmitter in a DVB-S2 system according to an exemplary embodiment of the present invention.

The satellite communication transmitter includes a modulator 100 and a spread spectrum unit 110. The modulator 100 may comply with the DVB-S2 standard. The spread spectrum unit 110 spreads out the modulated satellite communication signal complying with the DVB-S2 standard. The spread spectrum unit 110 may employ direct sequence spread spectrum (DSSS) to spread out the satellite communication signal.

The spread spectrum unit 110 includes a matched filter 120, a decimator 130, and a DSSS part 140. The matched filter 120 performs matched filtering on an orthogonal signal (I/Q coordinate system) which is output from the modulator 100. The orthogonal signal modulated by the modulator 100 which is used as a standard in the DVB-S2 system is a pulse-shaped signal, and the matched filter 120 performs matched filtering on the signal to restore it to an orthogonal signal with original I/Q coordinates.

The decimator 130 performs one sample decimation. Since the modulator 100 used as a standard in the DVB-S2 system performs oversampling, the decimator 130 performs sample decimation on an optimum sampling point of sampling points which are oversampled per symbol. In one embodiment, the decimator 130 receives ‘on timing information’, which is time axis information on an optimum sampling point, from the modulator 100 and performs one sample decimation.

In another embodiment, the spread spectrum unit 110 further includes an optimum sampling point calculator 190. The optimum sampling point calculator 190 detects a sampling rate from a signal output from the modulator 100 and checks the number of oversampling per symbol. In a case of 4 oversamples per symbol, the optimum sampling point calculator 190 calculates a sum of differences between each sample point value and an original optimum sample point value, 0.707, sets a point having a minimum value as an optimum sampling point, and provides ‘on timing information’ of the point set as an optimum sampling point to the decimator 130. The decimator 130 performs one sample decimation using the ‘on timing information’ from the optimum sampling point calculator 190. In a case where the ‘on timing information’ is not transmitted from the modulator 100 to the spread spectrum unit 110 but created in the spread spectrum unit 110, a modulator in an existing DVB-S2 system needs not to be modified.

The DSSS 140 includes a spread spectrum code part 150, a scrambling part 160, an oversampling part 170, and a pulse shaping part 180. The spread spectrum code part 150 multiplies a signal output from the decimator 130 by a spread spectrum code. The scrambling part 160 performs scrambling for spectrum flatness of the spread signal from the spread spectrum code part 150. The oversampling part 170 performs oversampling. The pulse shaping part 180 performs pulse shaping filtering by means of a pulse shaping filter. A module which is an identical model with the matched filter 120 and is used in the existing DVB-S2 may be used as the pulse shaping filter. A scrambling sequence may use a PL scramble code of the DVB-S2 standard. However, since the code may often be short in length, if a period ends, it may reset and continue to use the code.

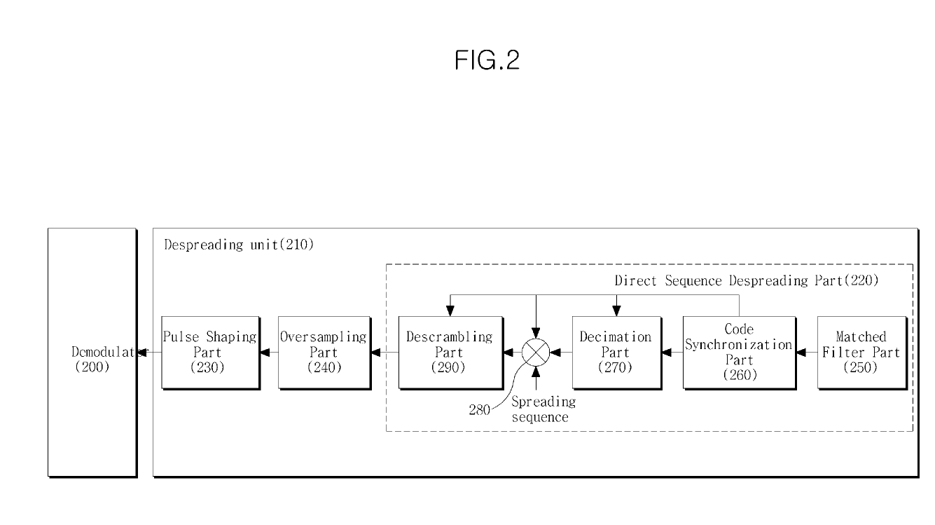

FIG. 2 is a block diagram of a satellite communication receiver in a DVB-S2 system according to an exemplary embodiment of the present invention.

The satellite communication receiver includes a demodulator 200 and a despreading unit 210. The demodulator 200 may comply with the DVB-S2 standard. Since the satellite communication receiver in the DVB-S2 system receives a spread satellite communication signal, the demodulator 200 cannot directly demodulate the spread signal. That is, the despreading unit 210 in the satellite communication receiver despreads the spread signal and outputs the despreaded signal to the demodulator 200 so that the demodulator 200 may demodulate the satellite communication signal. The despreading unit 210 employs a DSSS technique to despread the signal.

The despreading unit 210 includes a direct sequence despreading part 220, an oversampling part 230, and a pulse shaping part 240. The direct sequence despreading part 220 includes a matched filter part 250, a code synchronization part 260, a decimation part 270, a spread spectrum code part 280, and a descrambling part 290. The matched filter part 250 performs matched filtering on a received signal. The code synchronization part 260 performs code synchronization. The code synchronization may be divided into coarse synchronization for performing rough synchronization and fine synchronization for performing finer synchronization and maintaining the synchronization.

Coarse synchronization means finding start of frame (SOF) using a correlation function. Fine synchronization means adjusting a code symbol using delay locked loop (DLL) for correcting a chip timing error lower than a half chip. After adjusting chip timing, the decimation part 270 performs one sample decimation. The spread spectrum code part 280 multiplies a signal from the decimation part 270 by a spread spectrum code. The descrambling part 290 performs despreading by descrambling.

The oversampling part 240 performs oversampling on a descrambled signal. The pulse shaping part 240 performs pulse shaping on an oversampled signal and outputs it to the demodulator 200. In this case, oversampling and pulse shaping are performed as equally as in the modulator 100 in the DVB-S2 system, so that the demodulator 200 complying with the DVB-S2 standard can demodulate the signal.

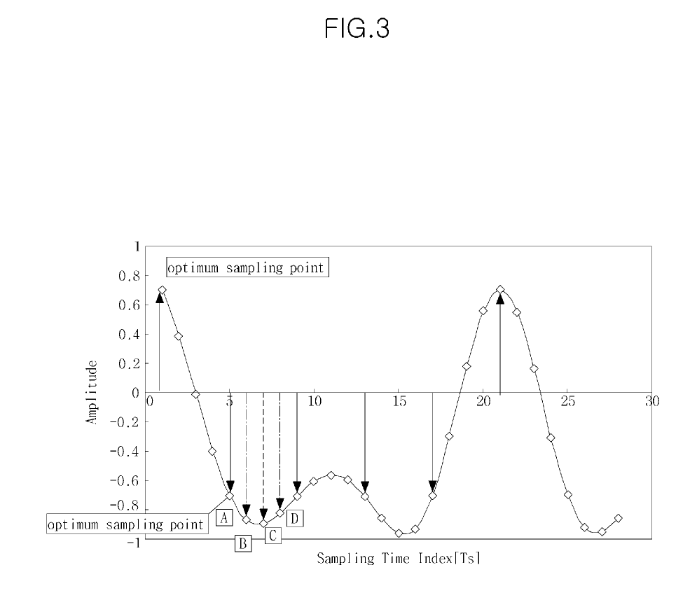

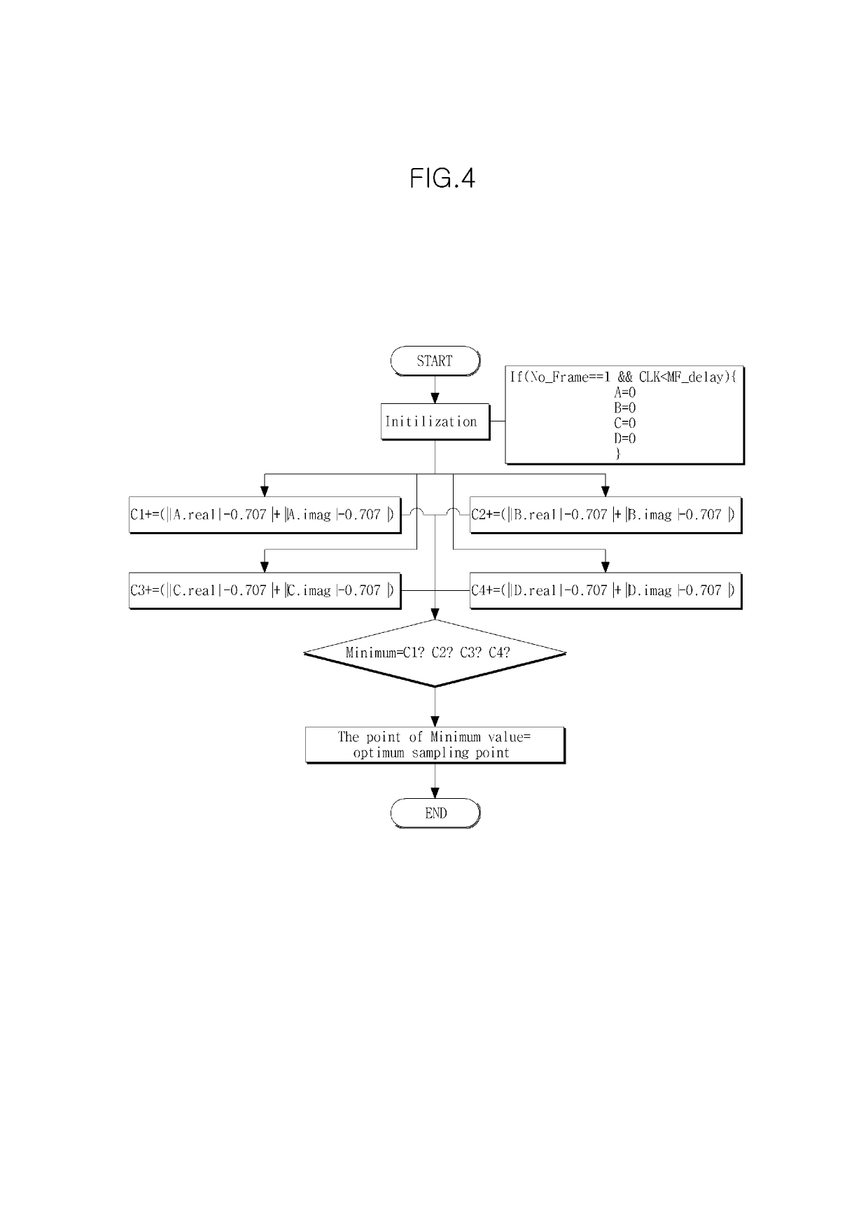

FIG. 3 is a graph illustrating oversampling points of a modulated satellite communication signal. FIG. 4 is a flow chart of calculation of ‘on timing information’.

FIG. 4 is an algorithm for finding an optimum sampling point for an oversampled signal, where there are 4 oversampling per symbol, for example. In a case where sampling points are set to ‘A’, ‘B’, ‘C’ and ‘D’, a sum of differences between each I/Q sampling value and an original sampling point value, 0.707, is found, and a point having a minimum value is set to an optimum sampling point and this process continues to apply for a certain period.

More specifically, as shown in FIG. 4, at S410, a sum of an absolute value of a difference between an absolute value of ‘A’ on a real axis and 0.707 and an absolute value of a difference between an absolute value of ‘A’ on an imaginary axis and 0.707 is calculated and set to ‘C1’. At S420, a sum of an absolute value of a difference between an absolute value of ‘B’ on a real axis and 0.707 and an absolute value of a difference between an absolute value of ‘B’ on an imaginary axis and 0.707 is calculated and set to ‘C2’. At S430, a sum of an absolute value of a difference between an absolute value of ‘C’ on a real axis and 0.707 and an absolute value of a difference between an absolute value of ‘C’ on an imaginary axis and 0.707 is calculated and set to ‘C3’. At S440, a sum of an absolute value of a difference between an absolute value of ‘D’ on a real axis and 0.707 and an absolute value of a difference between an absolute value of ‘D’ on an imaginary axis and 0.707 is calculated and set to ‘C4’. A minimum value of ‘C1, C2, C3 and C4’ is set to an optimum sampling point.

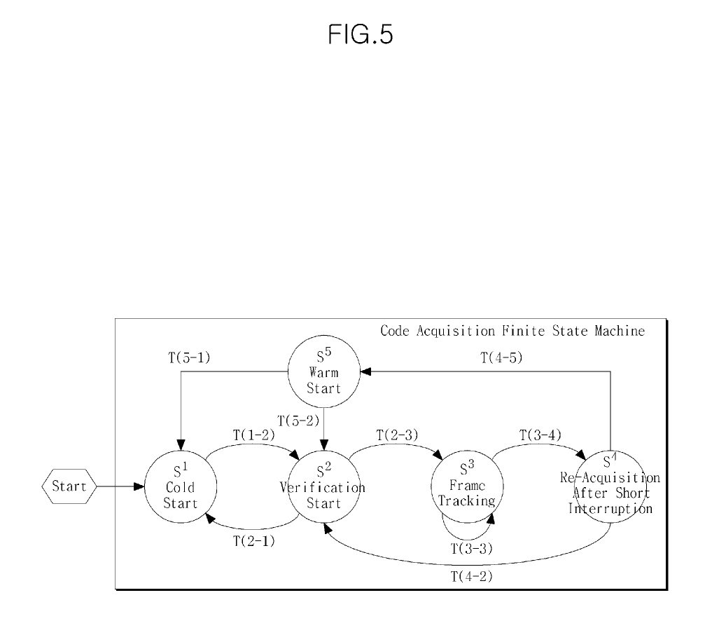

FIG. 5 is a state transition diagram for initial chip timing synchronization.

FIG. 5 illustrates a state transition diagram for initial chip timing synchronization in a satellite communication receiver. S1 is a state where an epoch point is found which is most probable as an initial start point for the entire frame length. S2 is a state where an epoch point is verified in frame periods after being locked. In an unlock state, all may be returned to a previous mode. S3 is a state where frames are kept tracking and is a mode for maintaining synchronization. S4 is a state where lock is lost due to an obstacle such as power arch and then is reacquired. S5 is a state where a frequency error is corrected and frame synchronization lock is maintained or being found.

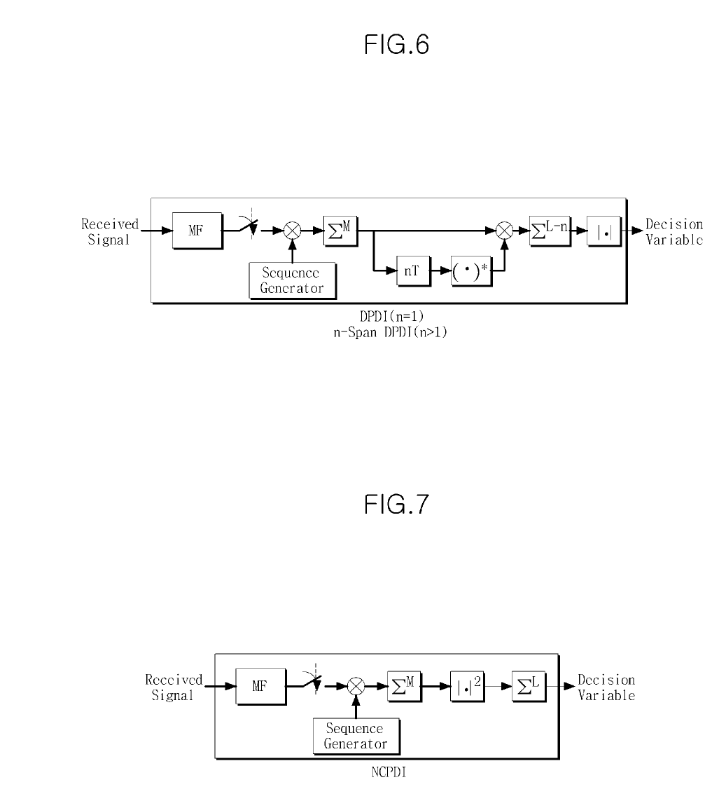

FIGS. 6 to 9 illustrate correlators for initial chip synchronization.

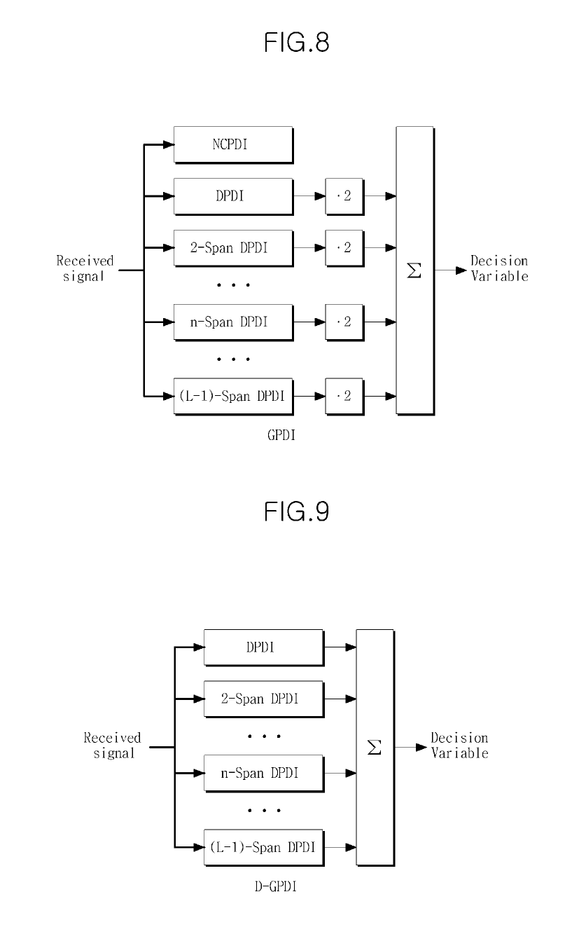

FIG. 6 illustrates a differential post detection integration (DPDI) correlator. FIG. 7 illustrates a non-coherent post detection integration (NCPDI) correlator. FIG. 8 illustrates a generalized post detection integration (GPDI) correlator. FIG. 9 illustrates a differential generalized post detection integration (D-GPDI) correlator. For DPDI, in order to obtain information on difference with a neighboring symbol, a difference phase is obtained with an interval of n symbols. If this is expanded by a length of ‘know’ signal, it becomes D-GPDI technique. The GPDI technique involves NCPDI which is an asynchronous correlator. If the known correlator is applied to the satellite communication receiver according to an embodiment of the present invention, the initial chip synchronization time is shortened.

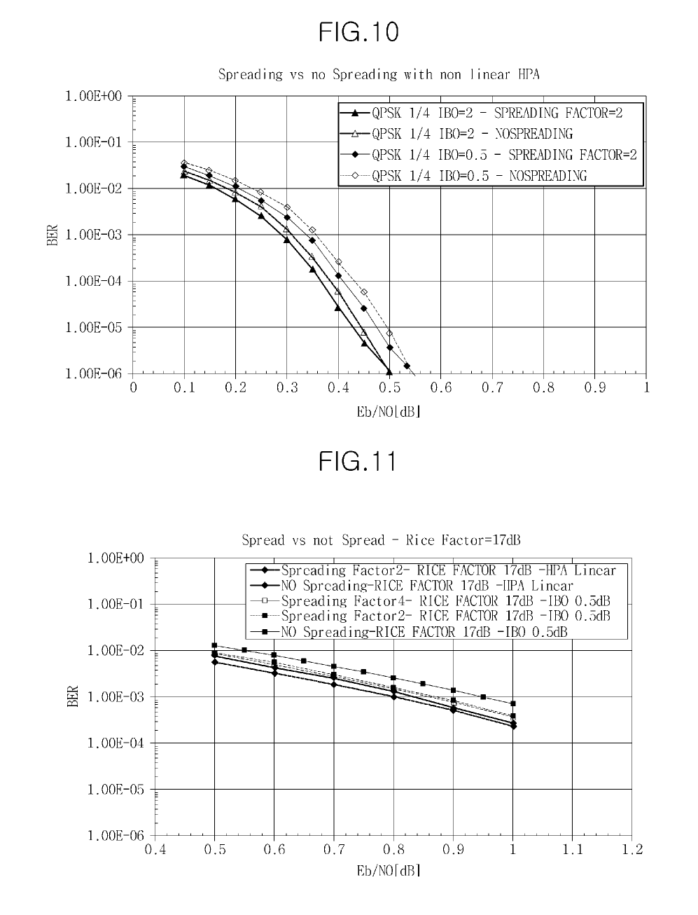

FIG. 10 is a graph for performance comparison of a non-linear amplifier model depending on spread spectrum. FIG. 11 is a graph for performance comparison of a mobile model depending on spread spectrum.

FIG. 10 is a graph for performance comparison of a non-linear amplifier model depending on spread spectrum in DVB-S2 standard. If a spreading factor is 2, Eb/No improves about 0.02 dB or more for input back off of 2 dB and 0.5 dB. In FIG. 11, a technique where spread spectrum is applied in ricean fading of 17 dB and IBO of 0.5 dB environment shows a performance improvement of about 0.1 dB or more. Hence, it can be seen that the direct sequence spread spectrum technique has an effect of removing an interference input to the outside.

As apparent from the above description, the direct sequence spread spectrum technique applied to the DVB-S2 system has an effect of performance improvement in a mobile Doppler environment and a non-linear amplification model as well as reduced interference of neighboring satellite channel. In particular, the present invention is compatible with DVB-S2 standard.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A satellite communication transmitter comprising a modulator to modulate a satellite communication signal to be transmitted, the satellite communication transmitter further comprising a spread spectrum unit to spread the modulated signal and transmit the spread signal.

2. The satellite communication transmitter of claim 1, wherein the satellite communication transmitter is configured to comply with DVB-S2 (Second Generation Digital Video Broadcasting via Satellite) standard.

3. The satellite communication transmitter of claim 2, wherein the spread spectrum unit employs a direct sequence spread spectrum (DSSS) technique to spread the signal output from the modulator.

4. The satellite communication transmitter of claim 3, wherein the spread spectrum unit comprises:
a matched filter to perform matched filtering on an orthogonal signal output from the modulator; and
a DSSS unit to spread the matched filtered orthogonal signal using the DSSS technique.

5. The satellite communication transmitter of claim 4, wherein the spread spectrum unit further comprises a decimator to perform one sample decimation per symbol on an oversampled signal output from the matched filter and output the decimated signal to the DSSS unit.

6. The satellite communication transmitter of claim 5, wherein the decimator receives information on an optimum sampling point, and performs decimation on an optimum sampling point among sampling points which are oversampled per symbol using the received information.

7. The satellite communication transmitter of claim 6, wherein the spread spectrum unit further comprises an optimum sampling point calculator which calculates an optimum sampling point among sampling points per symbol of the output signal from the modulator and outputs the optimum sampling point to the decimator.

8. The satellite communication transmitter of claim 7, wherein the optimum sampling point calculator calculates, as an optimum sampling point, a value of a sampling point closest to 0.707 on a real axis of rectangular coordinates among sampling points per symbol and a value of a sampling point closest to 0.707 on an imaginary axis of the rectangular coordinates among the sampling points per symbol.

9. The satellite communication transmitter of claim 5, wherein the DSSS unit comprises:
a spread spectrum code part to multiply the signal output from the decimator by a spread spectrum code; and
a scrambling part to scramble an output signal from the spread spectrum code part.

10. The satellite communication transmitter of claim 9, wherein the DSSS unit further comprises:
an oversampling part to perform oversampling on an output signal from the scrambling part; and
a pulse shaping part to perform pulse shaping filtering on an output signal from the oversampling part.

11. A satellite communication receiver comprising a demodulator to demodulate a satellite communication signal, the satellite communication receiver further comprising a despreading unit to despread the spread satellite communication signal and output the despreaded signal to the demodulator.

12. The satellite communication receiver of claim 11, wherein the satellite communication receiver is configured to comply with DVB-S2 (Second Generation Digital Video Broadcasting via Satellite) standard.

13. The satellite communication receiver of claim 12, wherein the despreading unit employs a direct sequence spread spectrum (DSSS) technique to perform despreading on a signal.

14. The satellite communication receiver of claim 13, wherein the despreading unit comprises:
a direct sequence despreading part to perform despreading on the received satellite communication signal using a DSSS technique;
an oversampling part to perform oversampling on the despreaded signal; and
a pulse shaping part to perform pulse shaping filtering on the despreaded signal.

15. The satellite communication receiver of claim 14, wherein the direct sequence despreading part comprises:
a matched filter part to perform matched filtering on the received satellite communication signal;
a code synchronization part to perform code synchronization on a signal output from the matched filter part;
a decimation part to perform one sample decimation per symbol on an oversampled signal output from the code synchronization part;
a spread spectrum code part to multiply a signal output from the decimation part by a spread spectrum code; and
a descrambling part to perform descrambling on a signal output from the spread spectrum code part.

16. The satellite communication receiver of claim 15, wherein the code synchronization part performs code synchronization by performing coarse synchronization and then performing fine synchronization.

17. The satellite communication receiver of claim 14, wherein the oversampling part performs oversampling similarly to a modulator in a satellite communication transmitter.

18. The satellite communication receiver of claim 14, wherein the pulse shaping part performs pulse shaping filtering similarly to a modulator in a satellite communication transmitter.
